(19) United States
(12) Patent Application Publication
(10) Pub. No.: US 2019/0112475 A1
(43) Pub. Date: Apr. 18, 2019

(54) Polyurethane Polyol, and Preparation Method and Application Thereof

(71) Applicant: NANJING TECH UNIVERSITY, Nanjing (CN)

(72) Inventors: Kai GUO, Nanjing (CN); Zheng FANG, Nanjing (CN); Wei HE, Nanjing (CN); Ning ZHU, Nanjing (CN); Xin HU, Nanjing (CN); Jiangkai QIU, Nanjing (CN); Chengkou LIU, Nanjing (CN); Jingjing MENG, Nanjing (CN); Jindian DUAN, Nanjing (CN); Pingkai OUYANG, Nanjing (CN)

(21) Appl. No.: 16/221,366

(22) Filed: Dec. 14, 2018

(30) Foreign Application Priority Data
Sep. 29, 2018 (CN) 201811153268.3

(51) Int. Cl. C08L 75/08; C07F 9/09; C08G 71/04; B01J 19/00

(52) U.S. Cl. CPC C08L 75/08; C07F 9/091; C08G 71/04; C08G 2101/0008; C08L 2201/02; C08L 2203/14; B01J 19/0093

(57) ABSTRACT

A polyurethane polyol, and a preparation method and application thereof. The method comprises the following steps: (1) carrying out a reaction on phosphorus oxychloride, epichlorohydrin, a first acidic catalyst and an inert solvent in a first microchannel reactor to obtain a chloroalkoxy phosphorus compound; (2) carrying out a reaction on the chloroalkoxy phosphorus compound, glycidol, a second acidic catalyst and an inert solvent in a second microchannel reactor to obtain a hydroxy compound; (3) carrying out a ring-opening reaction on the hydroxy compound, epoxy vegetable oil, a basic catalyst and an inert solvent in a third microchannel reactor to obtain a vegetable oil polyol; and (4) carrying out an addition polymerization reaction on the vegetable oil polyol, propylene oxide and an inert solvent in a fourth microchannel reactor to obtain the polyurethane polyol.

This application claims priority to Chinese Patent Application Ser. No. CN201811153268.3 filed on 29 Sep. 2018.

### TECHNICAL FIELD

The present invention relates to a polyurethane polyol, and a preparation method and application thereof. The polyurethane polyol can be used for preparing flame-retardant flexible polyurethane foam plastics.

### BACKGROUND ART

With the rapid development of modern industry, flexible polyurethane foam has been widely used in the fields of aviation, shipbuilding, automobiles, construction, chemical industry, electric appliances and the like. However, its flammability seriously affects its excellent performance and hinders the development of new markets. The United States, Western Europe, Japan and other countries have imposed strict laws and regulations on the flame retardancy of construction, electronics, transportation, entertainment, etc. China has also promulgated a series of regulations in recent years. Therefore, lowering the cost, widening the application range of the flexible foam and improving the flame retardancy of the foam are urgent problems to be solved in the polyurethane industry.

At present, there are mainly two flame-retarding methods for polyurethane foam: a flame retardant addition method and a reactive flame retardant method. The flame retardant addition method often causes foam collapse, cracking, powdering or great reduction of physical and mechanical properties such as rebound elasticity, so that the foam loses its own performance advantages; and the flame-retardant effects of these flame retardants are not significant when added alone. The reactive flame retardant method is to add a reactive flame retardant, such as a polyhydroxy compound containing a flame-retardant element such as phosphorus, chlorine, bromine, boron or nitrogen, into a flexible polyurethane foam formula, or introduce a flame-retardant element into a polyether glycol structure to obtain the flame retardancy. This method has the advantages of good flame retardancy durability, little impact on physical and mechanical properties and the like. The introduction of the flame-retardant element in polyether polyols enables polyurethane products to have higher heat resistance, dimensional stability and strength, and is currently the focus of research.

Patent CN103483575A discloses a preparation method of a polyether polyol used in flame-retardant slow-rebound polyurethane foam plastics, which comprises: mixing a small molecule alcohol with a phosphorus-containing compound to react to prepare an initiator, carrying out polymerization reaction on the initiator and oxidized olefin under the action of a catalyst to obtain a crude ether of the phosphorus-containing flame-retardant flexible foam polyether polyol, and carrying out neutralization, refinement, dewatering and filtration on the crude ether. Patent CN102875791A discloses a synthesis method of a flexible foam flame-retarding polyether polyol, which comprises: reacting a melamine-formaldehyde condensate with an amine compound, further polymerizing with an acidic compound to obtain a polyether initiator, and further polymerizing the polyether initiator and oxidized olefin under the action of an alkali metal catalyst to obtain the flame-retardant polyether glycol.

In summary, the flexible foam flame-retardant polyether polyols are mostly prepared by introducing a flame-retardant element containing phosphorus, chlorine, bromine, boron or nitrogen in the polymerization process of an active-hydrogen-containing compound (polyol or polyamine) and an epoxide (propylene oxide, ethylene oxide); polyether polyols used in flexible polyurethane foam generally have a large molecular weight, that is, large amounts of small molecular alcohols and epoxides are required, and these raw materials are derived from petroleum-derived products and have high dependence on petrochemical resources, high energy consumption, high environmental damage and high pollution; and because they are synthesized through a batch reactor, there exist the following defects: (1) long reaction time; (2) high energy consumption; (3) low equipment and automatic-control level; and (4) unavoidable side reactions, causing lower product quality.

### SUMMARY OF THE INVENTION

A purpose of the present invention is to provide a method for preparing a flame-retardant polyurethane polyol by a continuous process by introducing epoxy vegetable oil and a phosphorus or chlorine element, which aims to overcome the dependence of the existing preparation of polyurethane polyol on petrochemical resources so as to introduce the green renewable epoxy vegetable oil resource, and also aims to overcome the defects of long reaction time, higher energy consumption, low product quality and incapability of continuous production in a discontinuous process for producing a flame-retardant polyurethane polyol.

Another purpose of the present invention is to provide a polyurethane polyol prepared by the method.

A final purpose of the present invention is to provide application of the polyurethane polyol.

In order to achieve the above purposes, the technical solutions of the present invention are as follows:

A preparation method of a polyurethane polyol comprises the following steps:

(1) simultaneously pumping a solution A obtained by dissolving phosphorus oxychloride in an inert solvent and a solution B obtained by dissolving epichlorohydrin and a first acidic catalyst in an inert solvent into a first microchannel reactor of a microchannel reaction device to carry out a reaction, thereby obtaining a chloroalkoxy phosphorus compound;

(2) simultaneously pumping a solution C obtained by dissolving glycidol and a second acidic catalyst in an inert solvent and the chloroalkoxy phosphorus compound obtained in step (1) into a second microchannel reactor of the microchannel reaction device to carry out a reaction, thereby obtaining a hydroxy compound;

(3) simultaneously pumping a solution D obtained by dissolving epoxy vegetable oil and a basic catalyst in an inert solvent and the hydroxy compound obtained in step (2) into a third microchannel reactor of the microchannel reaction device to carry out a ring-opening reaction, thereby obtaining a vegetable oil polyol; and

(4) simultaneously pumping a solution E obtained by dissolving propylene oxide in an inert solvent and the vegetable oil polyol obtained in step (3) into a fourth microchannel reactor of the microchannel reaction device to carry out an addition polymerization reaction, thereby obtaining the polyurethane polyol having an flame-retardant effect.

A schematic diagram of synthesis of the present invention is shown in FIG. 2.

Preferably, the preparation method of the polyurethane polyol having a flame-retardant effect comprises the following steps:

(1) simultaneously pumping a solution A obtained by dissolving phosphorus oxychloride in an inert solvent and a solution B obtained by dissolving epichlorohydrin and a first acidic catalyst in an inert solvent into a first micromixer of a microchannel reaction device, thoroughly mixing, and introducing the mixture into a first microchannel reactor to carry out a reaction, thereby obtaining reaction effluent;

(2) simultaneously pumping a solution C obtained by dissolving glycidol and a second acidic catalyst in an inert solvent and the reaction effluent obtained in step (1) into a second micromixer of the microchannel reaction device, thoroughly mixing, and introducing the mixture into a second microchannel reactor to carry out a reaction, thereby obtaining reaction effluent containing a hydroxy compound;

(3) simultaneously pumping a solution D obtained by dissolving epoxy vegetable oil and a basic catalyst in an inert solvent and the reaction effluent containing a hydroxy compound obtained in step (2) into a third micromixer of the microchannel reaction device, thoroughly mixing, and introducing the mixture into a third microchannel reactor to carry out a ring-opening reaction, thereby obtaining reaction effluent containing a vegetable oil polyol; and

(4) simultaneously pumping a solution E obtained by dissolving propylene oxide in an inert solvent and the reaction effluent containing a vegetable oil polyol obtained in step (3) into a fourth micromixer of the microchannel reaction device, thoroughly mixing, and introducing the mixture into a fourth microchannel reactor to carry out an addition polymerization reaction, thereby obtaining the polyurethane polyol.

In step (1), the molar ratio of the phosphorus oxychloride to the epichlorohydrin to the first acidic catalyst is 1:(1.9-2.3):(0.02-0.08), preferably 1:(2.1-2.2):0.05, most preferably 1:2.1:0.05; the reaction temperature of the first microchannel reactor is 70-100° C., preferably 80-90° C., most preferably 80° C.; the reaction residence time is 5-10 min, preferably 5-7 min, most preferably 7 min; the volume of the first microchannel reactor is 2-8 ml, preferably 3.5 mL; and the flow rate of the solution A pumped into the microchannel reaction device is 0.1-0.8 ml/min, preferably 0.25-0.35 ml/min, most preferably 0.25 ml/min; and the flow rate of the solution B pumped into the microchannel reaction device is 0.1-0.8 ml/min, preferably 0.25-0.35 ml/min, most preferably 0.25 ml/min.

The inert solvent is any one or more of benzene, dichloroethylene, dichloroethane, chloroform, pentane, n-hexane, carbon tetrachloride and xylene, preferably carbon tetrachloride. The first acidic catalyst in step (1) and the second acidic catalyst in step (2) are each independently any one or more of sulfuric acid, hydrochloric acid, phosphoric acid, fluoroboric acid, aluminum chloride and ferric chloride, preferably aluminum chloride.

The molar ratio of the phosphorus oxychloride in step (1) to the glycidol in step (2) is 1:(1-1.3), preferably 1:1; the molar ratio of the phosphorus oxychloride to the second acidic catalyst is 1:(0.02-0.05), preferably 1:0.03; the reaction temperature of the second microchannel reactor is 70-100° C., preferably 80-90° C., most preferably 85° C.; the reaction residence time is 5-10 min, preferably 8 min; the volume of the second microchannel reactor is 2-32 ml, preferably 7-8 ml, most preferably 8 ml; and the flow rate of the solution C pumped into the microchannel reaction device is 0.2-1.6 ml/min, preferably 0.5-0.7 ml/min, most preferably 0.5 ml/min.

In step (3), the epoxy vegetable oil is any one or more of epoxy olive oil, epoxy peanut oil, epoxy rapeseed oil, epoxy cotton seed oil, epoxy soybean oil, epoxy coconut oil, epoxy palm oil, epoxy sesame oil, epoxy corn oil or epoxy sunflower oil, preferably epoxy soybean oil or epoxy cotton seed oil; the basic catalyst is any one or more of cesium carbonate, sodium carbonate, potassium carbonate, sodium hydroxide, potassium hydroxide, sodium bicarbonate, magnesium carbonate, triethylamine, pyridine or sodium methoxide, preferably cesium carbonate; the molar ratio of epoxy groups in the epoxy vegetable oil to the hydroxy compound is 1:(1-2), preferably 1:(1.1-1.3), most preferably 1:1.3; and the mass percentage of the basic catalyst to the epoxy vegetable oil is 0.02-0.1%.

In step (3), the reaction temperature of the third microchannel reactor is 90-140° C., preferably 110-120° C., most preferably 120° C.; the reaction residence time is 5-15 min, preferably 10-12 min, most preferably 10 min; the volume of the third microchannel reactor is 4-96 ml, preferably 20-33.6 mL, most preferably 20 mL; and the flow rate of the solution D pumped into the microchannel reaction device is 0.4-3.2 ml/min, preferably 1-1.4 ml/min, most preferably 1 ml/min.

In step (4), the molar ratio of epoxy groups in the epoxy vegetable oil to the propylene oxide is 1:(10-14), preferably 1:(10-11), most preferably 1:11; the reaction temperature of the fourth microchannel reactor is 80-150° C., preferably 110-130° C., most preferably 130° C.; the reaction residence time is 5-15 min, preferably 10-12 min, most preferably 12 min; the volume of the fourth microchannel reactor is 8-192 ml, most preferably 48 ml; and the flow rate of the solution E pumped into the microchannel reaction device is 0.8-6.4 ml/min, most preferably 2 ml/min.

In step (4), a discharge of the fourth microchannel reactor is subjected to pickling neutralization, liquid separation and rotary evaporation to obtain the polyurethane polyol.

The acid is any one or more of hydrochloric acid, sulfuric acid and phosphoric acid, preferably hydrochloric acid, and the mass percentage concentration of the hydrochloric acid is 5%.

The microchannel reaction device comprises a first micromixer, a first microchannel reactor, a second micromixer, a second microchannel reactor, a third micromixer, a third microchannel reactor, a fourth micromixer and a fourth microchannel reactor connected sequentially through pipes. A reaction material is fed into the micromixer and subsequent equipment through a precise low-pulse pump.

The first micromixer, the second micromixer, the third micromixer and the fourth micromixer are each independently a Y-type mixer, a T-type mixer or a slit plate mixer LH25.

The first microchannel reactor, the second microchannel reactor, the third microchannel reactor and the fourth microchannel reactor are each independently a polytetrafluoroethylene coil having an inner diameter of 0.5-2 mm, preferably a polytetrafluoroethylene coil having an inner diameter of 1.0 mm.

A polyurethane polyol prepared by the method.

Application of the polyurethane polyol in the preparation of flexible polyurethane foam.

As a new synthesis technology, microchannel reaction has certain applications in the fields of chemical engineering, synthesis, chemistry, pharmaceutical industry, analysis and biochemical processes, and is also an international research hotspot in the technical field of fine chemical industry. Compared with the conventional reaction system, the microchannel reaction has the advantages of high reaction selectivity, high mass transfer and heat transfer efficiency, high reaction activity, short reaction time, high conversion rate, good safety, easy control and the like. The application of the microchannel reaction technology in polyhydroxy compound ring-opening epoxy vegetable oil can improve the reaction efficiency, control the occurrence of side reactions and lower the energy consumption.

The present invention has the following beneficial effects: the preparation method has the advantages of continuous operation, simple and controllable preparation process, short reaction time, low energy consumption, low cost, short reaction time and fewer side reactions; the raw materials are green and environmentally friendly and have abundant sources; and the prepared polyurethane polyol has the advantages of light color, low viscosity and good fluidity, and has a flame-retardant effect due to the phosphorus or chlorine element contained therein. The flame-retardant flexible polyurethane foam material prepared by using the polyurethane polyol of the present invention has the characteristics of good flame-retardant effect, high oxygen index, low smoke density, good dimensional stability and high mechanical strength.

### BRIEF DESCRIPTION OF THE DRAWINGS

FIG. 1 is a schematic view of a microchannel reaction device; and

FIG. 2 is a schematic diagram of synthesis of a polyurethane polyol.

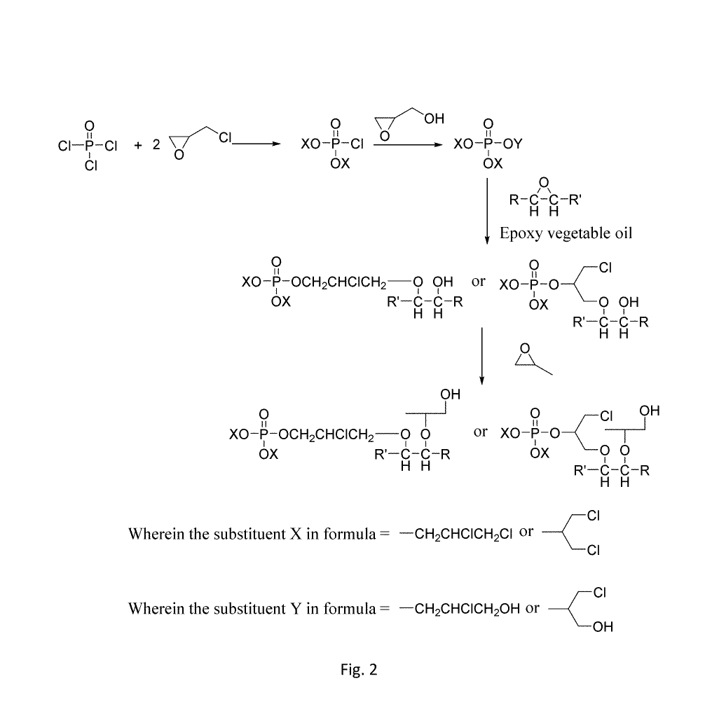

### DETAILED DESCRIPTION OF THE INVENTION

The related determination methods of the prepared polyurethane polyol and polyurethane foam of the present invention are as follows:

The hydroxyl value of the polyurethane polyol is determined according to the GB/T 12008.3-1989 method; the viscosity of the polyurethane polyol is determined according to the GB/T 12008.8-1992 method; the density of the polyurethane foam is determined according to the GB 6343-86; the tensile strength is determined according to the GB/T 1040-92 method; the rebound rate is determined according to the GB 6670-1997 method; the oxygen index is determined according to the GB/T 2406-1993 method; and the smoke density is determined according to the GB 8323-1987 method.

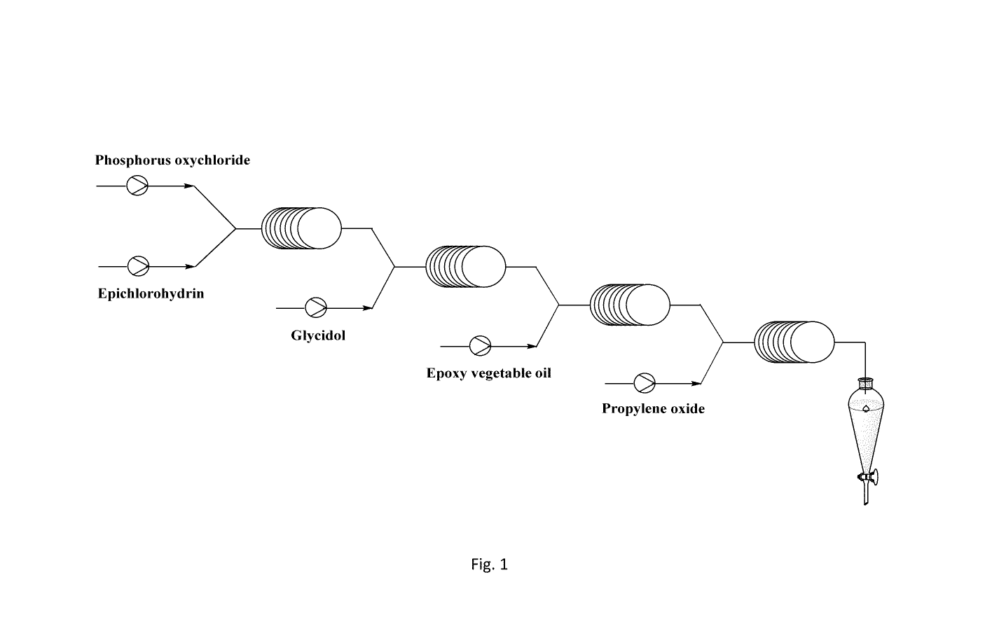

The microchannel reaction device described in the following examples, as shown in FIG. 1, comprises a first micromixer, a first microchannel reactor, a second micromixer, a second microchannel reactor, a third micromixer, a third microchannel reactor, a fourth micromixer and a fourth microchannel reactor connected sequentially through pipes. A reaction material is fed into the micromixer and subsequent equipment through a precise low-pulse pump.

The first micromixer, the second micromixer, the third micromixer and the fourth micromixer are each independently a Y-type mixer, a T-type mixer or a slit plate mixer LH25. The first microchannel reactor, the second microchannel reactor, the third microchannel reactor and the fourth microchannel reactor are each independently a polytetrafluoroethylene coil having an inner diameter of 1.0 mm.

### Example 1

153 g of phosphorus oxychloride was dissolved in 400 ml of carbon tetrachloride to obtain a solution A, 195 g of epichlorohydrin and 6.6 g of aluminum chloride were dissolved in 400 ml of carbon tetrachloride to obtain a mixed solution B, 74.08 g of glycidol and 4 g of aluminum chloride were dissolved in 800 ml of carbon tetrachloride to obtain a mixed solution C, 216 g of epoxy soybean oil and 0.06 g of cesium carbonate were dissolved in 1600 ml of carbon tetrachloride to obtain a mixed solution D, and 175 g of propylene oxide was dissolved in 3200 ml of carbon tetrachloride to obtain a solution E, wherein the molar ratio of the phosphorus oxychloride to the epichlorohydrin to the glycidol was 1:2.1:1, the molar ratio of epoxy groups in the epoxy vegetable oil to the hydroxy compound was 1:1.1, and the molar ratio of epoxy groups in the epoxy soybean oil to the propylene oxide was 1:11; the solution A and the solution B were simultaneously pumped into a first micromixer respectively, thoroughly mixed, and introduced into a first microchannel reactor to react, thereby obtaining reaction effluent; the reaction effluent and the solution C were simultaneously pumped into a second micromixer respectively, thoroughly mixed, introduced into a second microchannel reactor to react, thereby obtaining reaction effluent containing a hydroxy compound; the reaction effluent containing a hydroxy compound and the solution D were simultaneously pumped into a third micromixer respectively, thoroughly mixed, and introduced into a third microchannel reactor to be subjected to a ring-opening reaction, thereby obtaining reaction effluent containing a vegetable oil polyol; the reaction effluent and the solution E were simultaneously pumped into a fourth micromixer respectively, thoroughly mixed, and introduced into a fourth microchannel reactor to carry out an addition polymerization reaction, wherein the flow rates of the solutions A, B, C, D and E were respectively 0.25 ml/min, 0.25 ml/min, 0.5 ml/min, 1 ml/min and 2 ml/min; the first microchannel reactor of the microchannel reaction device had a volume of 3.5 ml, a reaction temperature of 80° C., and a reaction time of 7 min; the second microchannel reactor had a volume of 8 ml, a reaction temperature of 85° C., and a reaction time of 8 min; the third microchannel reactor had a volume of 20 ml, a reaction temperature of 120° C., and a reaction time of 10 min; and the fourth microchannel reactor had a volume of 48 ml, a reaction temperature of 130° C., and a reaction time of 12 min. The product after the completion of the reaction was introduced into a separator and allowed to stand for stratification, the lower aqueous solution was removed, the upper organic phase was neutralized with 5 wt % hydrochloric acid and washed to a pH value of 6.5-7.5, liquid separation was carried out, and the organic phase was subjected to rotary evaporation and drying to obtain the polyurethane polyol.

### Example 2

153 g of phosphorus oxychloride was dissolved in 400 ml of carbon tetrachloride to obtain a solution A, 203.5 g of epichlorohydrin and 6.6 g of aluminum chloride were dissolved in 400 ml of carbon tetrachloride to obtain a mixed solution B, 96 g of glycidol and 4 g of aluminum chloride were dissolved in 800 ml of carbon tetrachloride to obtain a mixed solution C, 308 g of epoxy soybean oil and 0.09 g of cesium carbonate were dissolved in 1600 ml of carbon tetrachloride to obtain a mixed solution D, and 145 g of propylene oxide was dissolved in 3200 ml of carbon tetrachloride to obtain a solution E, wherein the molar ratio of the phosphorus oxychloride to the epichlorohydrin to the glycidol was 1:2.2:1.3, the molar ratio of epoxy groups in the epoxy vegetable oil to the hydroxy compound was 1:1.3, and the molar ratio of epoxy groups in the epoxy soybean oil to the propylene oxide was 1:10; the volumes of the four series connected microchannel reactors of the microchannel reaction device, the flow rates of the solutions A, B, C, D and E, and the times and temperatures of the microchannel reactions were the same as those in example 1. The product after the completion of the reaction was introduced into a separator and allowed to stand for stratification, the lower aqueous solution was removed, the upper organic phase was neutralized with 5 wt % hydrochloric acid and washed to a pH value of 6.5-7.5, liquid separation was carried out, and the organic phase was subjected to rotary evaporation and drying to obtain the polyurethane polyol.

### Example 3

Different from example 1, the reaction temperatures of the four microchannel reactors were respectively 80° C., 90° C., 110° C. and 115° C.

### Example 4

Different from example 1, the flow rates of the solutions A, B, C, D and E were respectively 0.35 ml/min, 0.35 ml/min, 0.7 ml/min, 1.4 ml/min and 2.8 ml/min; the first microchannel reactor had a volume of 3.5 ml and a reaction time of 5 min; the second microchannel reactor had a volume of 7 ml and a reaction time of 5 min; the third microchannel reactor had a volume of 33.6 ml and a reaction time of 12 min; and the fourth microchannel reactor had a volume of 56 ml and a reaction time of 10 min.

### Example 5

Different from example 1, the epoxy vegetable oil was epoxy rapeseed oil, that is, 250 g of epoxy rapeseed oil and 0.075 g of cesium carbonate were dissolved in 1600 ml of carbon tetrachloride to obtain a solution D, and 145 g of propylene oxide was dissolved in 3200 ml of carbon tetrachloride to obtain a solution E, wherein the molar ratio of the phosphorus oxychloride to the epichlorohydrin to the glycidol was 1:2.1:1, the molar ratio of epoxy groups in the epoxy vegetable oil to the hydroxy compound was 1:1.1, and the molar ratio of epoxy groups in the epoxy rapeseed oil to the propylene oxide was 1:10.

### Example 6

Different from example 1, the epoxy vegetable oil was epoxy palm oil, that is, 533 g of epoxy palm oil and 0.26 g of cesium carbonate were dissolved in 1600 ml of carbon tetrachloride to obtain a solution D, and 570 g of propylene oxide was dissolved in 3200 ml of carbon tetrachloride to obtain a solution E, wherein the molar ratio of the phosphorus oxychloride to the epichlorohydrin to the glycidol was 1:2.1:1, the molar ratio of epoxy groups in the epoxy vegetable oil to the hydroxy compound was 1:1.1, and the molar ratio of epoxy groups in the epoxy palm oil to the propylene oxide was 1:12.

### Example 7

Different from example 1, the epoxy vegetable oil was epoxy corn oil, that is, 250 g of epoxy corn oil and 0.075 g of cesium carbonate were dissolved in 1600 ml of carbon tetrachloride to obtain a solution D, and 145 g of propylene oxide was dissolved in 3200 ml of carbon tetrachloride to obtain a solution E, wherein the molar ratio of the phosphorus oxychloride to the epichlorohydrin to the glycidol was 1:2.1:1, the molar ratio of epoxy groups in the epoxy vegetable oil to the hydroxy compound was 1:1.1, and the molar ratio of epoxy groups in the epoxy corn oil to the propylene oxide was 1:10.

Table 1 shows performance indexes of the polyurethane polyols prepared in examples 1-7 and performance indexes of the product obtained in the prior art (example 6 in Patent CN101054436A). The polyurethane polyol obtained in examples 1-7 was used to prepare polyurethane foam according to the formula described in Table 2 without adding other flame retardants, and the performance indexes of the obtained products are shown in Table 3.

TABLE 1
Performance index of polyurethane polyol

| Performance | | | | | | | | Existing |
|---|---|---|---|---|---|---|---|---|
| Index | Example 1 | Example 2 | Example 3 | Example 4 | Example 5 | Example 6 | Example 7 | Product |
| Hydroxyl Value | 42 | 31 | 30 | 33 | 40 | 30 | 32 | 32.5 |
| mgKOH/g | | | | | | | | |
| Viscosity | 600 | 710 | 800 | 760 | 640 | 920 | 700 | 950 |
| mPas/25° C. | | | | | | | | |

It can be seen from Table 1 that the polyurethane polyol obtained by the method of the present invention has low viscosity, good fluidity and good stability.

TABLE 2
Foaming formula of polyurethane foam

| | Parts by Mass | Parts by Mass |
|---|---|---|
| Component A | (Basic Formula) | (Foaming Formula) |
| Ordinary 330N Polyether | 40-60 | 50 |
| Polyurethane Polyol | 60-40 | 50 |
| Silicone Oil L-580 | 0.6-1.5 | 1.0 |
| Water | 3-5 | 3.3 |
| Crosslinker L | 1-2 | 1.0 |
| Cell Opener | 0.5-2 | 1.0 |
| Triethanolamine | 0.5-1.5 | 0.7 |
| Component B | | |
| TDI | 40-60 | 60 |
| MDI | 20-40 | 40 |
| Index | 1.05 | 1.05 |

Note:
Material temperature 25° C.

TABLE 3
Performance index of flame-retardant polyurethane foam

| Performance | Embodiment | | | | | | | Existing |
|---|---|---|---|---|---|---|---|---|
| Index | 1 | Embodiment 2 | Embodiment 3 | Embodiment 4 | Embodiment 5 | Embodiment 6 | Embodiment 7 | Product |
| Oxygen | 33 | 32 | 36 | 30 | 31 | 29 | 32 | 28.5 |
| Index/OI | | | | | | | | |
| Rebound | 62 | 61 | 62 | 64 | 61 | 58 | 63 | 60 |
| Rate/% | | | | | | | | |
| Tensile | 129 | 127 | 130 | 126 | 127 | 120 | 131 | 125 |
| Strength/KPa | | | | | | | | |
| Smoke | 32 | 34 | 33 | 39 | 38 | 40 | 37 | 57 |
| Density/% | | | | | | | | |

It can be seen from Table 3 that under the condition of not using other liquid and solid flame retardants, the flame-retardant polyurethane foam product prepared by foaming the flexible foam flame-retardant polyurethane polyol obtained by the method provided by the present invention has a high oxygen index, a good flame-retardant effect, high heat resistance, good dimensional stability and high strength, and can replace the existing product.

### Example 8

This example is the same as example 1, except that:

The first and second acidic catalysts were sulfuric acid, the inert solvent was dichloroethylene, the epoxy vegetable oil was epoxy olive oil, the basic catalyst was sodium carbonate, the molar ratio of the phosphorus oxychloride to the epichlorohydrin to the first acidic catalyst was 1:1.9:0.02, the molar ratio of the phosphorus oxychloride to the second acidic catalyst was 1:0.02, and the molar ratio of epoxy groups in the epoxy vegetable oil to the hydroxy compound was 1:1; and the mass percentage of the basic catalyst to the epoxy vegetable oil was 0.02%, and the molar ratio of epoxy groups in the epoxy vegetable oil to the propylene oxide was 1:10. After test, the obtained polyurethane polyol was found to have similar performance to the polyurethane polyol obtained in example 1.

### Example 9

This example is the same as example 1, except that:

The first and second acidic catalysts were hydrochloric acid, the inert solvent was dichloroethane, the epoxy vegetable oil was epoxy peanut oil, the basic catalyst was potassium hydroxide, the molar ratio of the phosphorus oxychloride to the epichlorohydrin to the first acidic catalyst was 1:2.3:0.08, the molar ratio of the phosphorus oxychloride to the second acidic catalyst was 1:0.05, and the molar ratio of epoxy groups in the epoxy vegetable oil to the hydroxy compound was 1:2; and the mass percentage of the basic catalyst to the epoxy vegetable oil was 0.1%, and the molar ratio of epoxy groups in the epoxy vegetable oil to the propylene oxide was 1:14. After test, the obtained polyurethane polyol was found to have similar performance to the polyurethane polyol obtained in example 1.

### Example 10

This example is the same as example 1, except that:

The first and second acidic catalysts were fluoroboric acid, the inert solvent was chloroform, the epoxy vegetable oil was epoxy rapeseed oil, and the basic catalyst was triethylamine. The reaction temperature of the first microchannel reactor was 70° C., the reaction residence time was 10 min, and the volume of the first microchannel reactor was 2 ml; the reaction temperature of the second microchannel reactor was 70° C., the reaction residence time was 10 min, and the volume of the second microchannel reactor was 2 ml; the reaction temperature of the third microchannel reactor was 90° C.; the reaction residence time was 15 min, and the volume of the third microchannel reactor was 4 ml; the reaction temperature of the fourth microchannel reactor was 80° C.; and the reaction residence time was 15 min, and the volume of the fourth microchannel reactor was 8 ml. After test, the obtained polyurethane polyol was found to have similar performance to the polyurethane polyol obtained in example 1.

### Example 11

This example is the same as example 1, except that:

The first and second acidic catalysts were ferric chloride, the inert solvent was n-hexane, the epoxy vegetable oil was epoxy corn oil, and the basic catalyst was sodium methoxide. The reaction temperature of the first microchannel reactor was 100° C., the reaction residence time was 5 min, and the volume of the first microchannel reactor was 8 ml; the reaction temperature of the second microchannel reactor was 100° C., the reaction residence time was 5 min, and the volume of the second microchannel reactor was 32 ml; the reaction temperature of the third microchannel reactor was 140° C.; the reaction residence time was 5 min, and the volume of the third microchannel reactor was 96 ml; the reaction temperature of the fourth microchannel reactor was 150° C.; and the reaction residence time was 5 min, and the volume of the fourth microchannel reactor was 192 ml. After test, the obtained polyurethane polyol was found to have similar performance to the polyurethane polyol obtained in example 1.

What is claimed is:

1. A preparation method of a polyurethane polyol, characterized by comprising the following steps:
(1) simultaneously pumping a solution A obtained by dissolving phosphorus oxychloride in an inert solvent and a solution B obtained by dissolving epichlorohydrin and a first acidic catalyst in an inert solvent into a first microchannel reactor of a microchannel reaction device to carry out a reaction, thereby obtaining a chloroalkoxy phosphorus compound;
(2) simultaneously pumping a solution C obtained by dissolving glycidol and a second acidic catalyst in an inert solvent and the chloroalkoxy phosphorus compound obtained in step (1) into a second microchannel reactor of the microchannel reaction device to carry out a reaction, thereby obtaining a reaction solution containing a hydroxy compound;
(3) simultaneously pumping a solution D obtained by dissolving epoxy vegetable oil and a basic catalyst in an inert solvent and the hydroxy compound obtained in step (2) into a third microchannel reactor of the microchannel reaction device to carry out a ring-opening reaction, thereby obtaining a vegetable oil polyol; and
(4) simultaneously pumping a solution E obtained by dissolving propylene oxide in an inert solvent and the vegetable oil polyol obtained in step (3) into a fourth microchannel reactor of the microchannel reaction device to carry out an addition polymerization reaction, thereby obtaining the polyurethane polyol.

2. The method according to claim 1, characterized in that in step (1), the molar ratio of the phosphorus oxychloride to the epichlorohydrin to the first acidic catalyst is 1:(1.9-2.3):(0.02-0.08); the reaction temperature of the first microchannel reactor is 70-100° C.; the reaction residence time is 5-10 min; the volume of the first microchannel reactor is 2-8 ml; and the flow rate of the solution A pumped into the microchannel reaction device is 0.1-0.8 ml/min; and the flow rate of the solution B pumped into the microchannel reaction device is 0.1-0.8 ml/min.

3. The method according to claim 1, characterized in that the inert solvent is any one or more of benzene, dichloroethylene, dichloroethane, chloroform, pentane, n-hexane, carbon tetrachloride and xylene; and the first acidic catalyst in step (1) and the second acidic catalyst in step (2) are each independently any one or more of sulfuric acid, hydrochloric acid, phosphoric acid, fluoroboric acid, aluminum chloride and ferric chloride.

4. The method according to claim 1, characterized in that the molar ratio of the phosphorus oxychloride in step (1) to the glycidol in step (2) is 1:(1-1.3); the molar ratio of the phosphorus oxychloride to the second acidic catalyst is 1:(0.02-0.05); the reaction temperature of the second microchannel reactor is 70-100° C.; the reaction residence time is 5-10 min; the volume of the second microchannel reactor is 2-32 ml; and the flow rate of the solution C pumped into the microchannel reaction device is 0.2-1.6 ml/min.

5. The method according to claim 1, characterized in that in step (3), the epoxy vegetable oil is any one or more of epoxy olive oil, epoxy peanut oil, epoxy rapeseed oil, epoxy cotton seed oil, epoxy soybean oil, epoxy coconut oil, epoxy palm oil, epoxy sesame oil, epoxy corn oil or epoxy sunflower oil; the basic catalyst is any one or more of cesium carbonate, sodium carbonate, potassium carbonate, sodium hydroxide, potassium hydroxide, sodium bicarbonate, magnesium carbonate, triethylamine, pyridine or sodium methoxide; the molar ratio of epoxy groups in the epoxy vegetable oil to the hydroxy compound is 1:(1-2); and the mass percentage of the basic catalyst to the epoxy vegetable oil is 0.02-0.1%.

6. The method according to claim 1, characterized in that in step (3), the reaction temperature of the third microchannel reactor is 90-140° C.; the reaction residence time is 5-15 min; the volume of the third microchannel reactor is 4-96 ml; and the flow rate of the solution D pumped into the microchannel reaction device is 0.4-3.2 ml/min.

7. The method according to claim 1, characterized in that in step (4), the molar ratio of epoxy groups in the epoxy vegetable oil to the propylene oxide is 1:(10-14); the reaction temperature of the fourth microchannel reactor is 80-150° C.; the reaction residence time is 5-15 min; the volume of the fourth microchannel reactor is 8-192 ml; and the flow rate of the solution E pumped into the microchannel reaction device is 0.8-6.4 ml/min.

8. The method according to claim 1, characterized in that the microchannel reaction device comprises a first micromixer, a first microchannel reactor, a second micromixer, a second microchannel reactor, a third micromixer, a third microchannel reactor, a fourth micromixer and a fourth microchannel reactor connected sequentially through pipes.

9. A polyurethane polyol, wherein the polyurethane polyol prepared by a method according to claim 1.

10. A process for using a polyurethane polyol of claim 9, wherein the process uses the polyurethane polyol for preparing a flexible polyurethane foam.
